(19) United States
(12) Patent Application Publication
(10) Pub. No.: US 2013/0098615 A1
(43) Pub. Date: Apr. 25, 2013

(54) NOVEL HIGH DENSITY BRINES FOR COMPLETION APPLICATIONS

(71) Applicants: GREGORY PAUL PEREZ, Pearland, TX (US); JAY PAUL DEVILLE, Spring, TX (US)

(72) Inventors: GREGORY PAUL PEREZ, Pearland, TX (US); JAY PAUL DEVILLE, Spring, TX (US)

(73) Assignee: HALLIBURTON ENERGY SERVICES, INC., Houston, TX (US)

(21) Appl. No.: 13/276,921

(22) Filed: Oct. 19, 2011

(51) Int. Cl. E21B 43/11; C09K 8/05; C09K 8/58

(52) U.S. Cl. 166/297; 507/272; 507/277; 507/145

(57) ABSTRACT

Clear, high density brine for use completion operations in a subterranean formation for the recovery of hydrocarbons. The brine comprises an ionic compound selected from the group consisting of zinc iodide, strontium bromide, strontium iodide, cerium bromide, cerium iodide, cerium chloride, lanthanum bromide, lanthanum iodide, lanthanum chloride, and mixtures thereof. The brine may also advantageously be used as the internal phase of invert emulsion drilling fluids.

### BACKGROUND OF THE INVENTION

1. Field of the Invention

The present invention relates to drilling and completion fluids for use in hydrocarbon bearing subterranean formations and to methods of drilling and completing subterranean zones using those fluids.

2. Description of Relevant Art

Various procedures have been used to increase the flow of hydrocarbons from hydrocarbon-containing subterranean formations penetrated by wellbores. A commonly used technique involves perforating the formation to provide flow channels through which hydrocarbons flow from the formation to the wellbore. The goal is to leave the formation with maximum permeability or conductivity so that formation hydrocarbons flow to the wellbore with the least possible restriction. This can be accomplished by: (1) preventing the entry of solids into the formation, which could decrease the permeability of the formation; (2) using well completion fluids that do not tend to swell and/or disperse formation particles contacted by the completion fluid; (3) preventing the entry of formation particles into the perforations; and (4) avoiding excessive invasion of wellbore fluids into the formation.

Specially formulated fluids are used in connection with completion and workover operations to minimize damage to the formation. Completion fluids are used after drilling is complete and during the steps of completion, or recompletion, of the well. Completion operations normally include cementing the casing, perforating the casing and setting the tubing and pumps prior to, and to facilitate, initiation of production in hydrocarbon recovery operations. Workover fluids are used during remedial work in the well, such as removing tubing, replacing a pump, logging, reperforating, and cleaning out sand or other deposits.

The various functions of drill-in, completion and workover fluids include controlling well pressure, preventing the well from blowing out during completion or workover, and preventing the collapse of the well casing due to excessive pressure build-up. The fluid is meant to help control a well without damaging the producing formation or completion components. Specific completion fluid systems are selected to optimize the well completion operation in accordance with the characteristics of a particular geological formation.

“Drill-in” drilling fluids, used in drilling through a producing zone of a hydrocarbon bearing subterranean formation, and completion fluids, used in completing or recompleting or working over a well, are typically comprised of clear brines. As used herein, a “producing zone” is understood to be a portion of a hydrocarbon bearing subterranean formation that contains hydrocarbons; and thus a wellbore penetrating such portion of the formation is likely to receive hydrocarbons from the zone for production. A “producing zone” may alternatively be called a “production zone” or a “pay zone.”

Seldom is a regular drilling fluid suitable for completion operations due to its solids content, pH and ionic composition. Drill-in fluids can, in some cases be suitable for both drilling and completion work. Fluids can contain suspended solid matter consisting of particles of many different sizes. Some suspended material will be large enough and heavy enough to settle rapidly to the bottom of a container if a liquid sample is left to stand (the settable solids). Very small particles will settle only very slowly or not at all if the sample is regularly agitated or the particles are colloidal. These small solid particles cause the liquid to appear turbid (i.e., cloudy or hazy). The potential of particle invasion and/or filter cake buildup to damage a formation by reducing permeability in the producing zone has been recognized for many years. If permeability gets damaged, it is difficult to restore. Loss in permeability can mean a decrease in anticipated production rates and ultimately in a decrease in production overall.

Thus, the importance of using clear completion and workover fluids to minimize formation damage is now well recognized and the use of clear heavy brines as completion fluids is now widespread. Most such heavy brines used by the oil and gas industry are calcium halide brines, particularly calcium chloride or calcium bromide brines, sodium halide brines, particularly sodium chloride or sodium bromide, potassium chloride, zinc bromide, or formate brines, particularly potassium or cesium formate.

As used herein, the terms “completion fluids” and “completion brines” shall be understood to be synonymous with each other and to include drill-in and workover fluids or brines as well as completion fluids or brines, unless specifically indicated otherwise.

The search for oil and gas has led to greater challenges in recent years, including increased emphasis on environmental compatibility of fluids used in drilling and safety concerns for rig personnel and other handlers of the fluids. There is a need for more options in improved fluids, particularly for completion and workover and drill-in operations.

### SUMMARY OF THE INVENTION

The present invention provides new ionic compounds that are suitable for use in providing density to brines for use in completion applications in subterranean formations, and also for use as the internal phase of invert emulsions used in invert emulsion drilling fluids for drilling applications in subterranean formations. These ionic compounds include zinc iodide, strontium halides and rare earth halides and are capable of providing or adding brine density without particulates that may be damaging to a subterranean formation.

### DETAILED DESCRIPTION OF PREFERRED EMBODIMENTS

Completion fluids (brines) generally comprise a large amount of an ionic compound (a salt) dissolved in water in order to achieve a desired density. Densities achievable with brines typically range from about 8.5 to greater than 20 lb/gal. Such brines are preferred over fluids with solid, undissolved weighting agents for completion applications because the solid weighting agents are often thought to be responsible for unwanted damage to the reservoir section of the formation.

The present invention identifies ionic compounds particularly suitable for adding density to completion brines. The ionic compounds of the present invention are not only water soluble, but they provide a clear solution in water and yield a density to the water greater than 10 lb/gal. The ionic compounds of the present invention also meet and exceed oil industry standards for safety, to the environment and to drilling rig personnel using the brines in drilling and completions operations. Further, the ionic compounds of the present invention are sufficiently available to make their use practicable.

One of the ionic compounds comprising completion brines of the present invention is zinc iodide. While zinc bromide is currently used in completion brines, zinc iodide is not. However, zinc iodide has high atomic mass and is highly soluble in water. In theory, zinc iodide can provide 432 grams of weight per 100 milliliters of water. In practice, zinc iodide brines may be used as completion fluids having a density of about 22.6 lb/gal. This density can be highly desirable for completion brines and prior to the present invention has been considered difficult to achieve with clear brines. In its simplest and most preferred form, a zinc iodide completion brine of the present invention comprises only zinc iodide and water.

Other ionic compounds comprising completion brines of the present invention are strontium halides. In addition to possessing a large atomic mass (87.6 g/mol), strontium is one of the most abundant elements in the earth's crust, even more abundant than zinc. Pairing strontium with halogens yield compounds of high formula weight and substantial water solubility. In theory, strontium bromide can provide 102 grams of weight per 100 milliliters of water and strontium iodide can provide 178 grams of weight per 100 milliliters of water. In practice, strontium bromide brines may be used as completion fluids having a density of 13.9 lb/gal and strontium iodide brines may be used as completion fluids having a density of 17.1 lb/gal. In its simplest and most preferred form, a strontium halide completion brine of the present invention comprises only strontium bromide, or strontium iodide, and water.

Further ionic compounds comprising completion brines of the present invention are rare earth halides, most preferably cerium and lanthanum halides. Cerium has a desired high atomic mass (140.1 grams per mole and is abundant in the earth's crust, making up the 25^{th} most abundant element, more abundant than copper. Lanthanum also has a high atomic mass (138.9 grams per mole) and is the 28^{th} most abundant element in the earth's crust (more abundant than cobalt). Pairing cerium and/or lanthanum with bromine, iodine, or chlorine yields compounds of high formula weight and substantial water solubility. Cerium chloride has a theoretical solubility of 100 grams per 100 milliliters of water. A saturated aqueous cerium chloride may be used as a completion fluid having a density of 13.5 lb/gal. A saturated aqueous lanthanum chloride may be used as a completion fluid having a density of 13.6 lb/gal. In its simplest and most preferred form, rare earth halide completion brines of the present invention comprise only the rare earth halide, particularly cerium and/or lanthanum and water.

Table I summarizes data from experimentally prepared solutions of the ionic compounds of the present invention in water, comprising simple completion fluids.

TABLE I

| | Experimental | | | |
|---|---|---|---|---|
| Ionic | Density | | Solid Density | Formula weight |
| Compound | (g/ml/lb/gal) | pH | (g/ml) | (g/mol) |
| ZnI₂ | 2.7061/22.58 | 1.02 | 4.74 | 319.18 |
| SrI₂ | 2.0436/17.05 | 8.2 | 5.46 | 341.4 |
| SrBr₂ | 1.6620/13.87 | 6.2 | 4.22 | 247.43 |
| CeCl₃ | 1/6153/13.48 | 3.7 | 3.97 | 246.46 |
| LaCl₃ | 1/6285/13.59 | 3.8 | 3.84 | 245.26 |

Various mixtures of the ionic compounds of the present invention might be used in water to comprise a completion brine of the invention. Although not preferred, the brines of the present invention may also be mixed with conventional completion brines.

The brines of the present invention, preferably comprising essentially the ionic compounds of the invention and water, also have utility as the internal phase of invert emulsion drilling fluids. That is, the brines of the present invention can be substituted for calcium chloride brines commonly used in (and typically comprising about 25% of) invert emulsion drilling fluids. This use of the brines of the present invention affords enhanced density to the drilling fluid, and provides potential advantages of allowing for reduced use of weighting agents and solids in the fluids. This use of the brines of the present invention is also believed to provide potential advantages in shale stability.

The foregoing description of the invention is intended to be a description of preferred embodiments. Various changes in the details of the described fluids and methods of use can be made without departing from the intended scope of this invention as defined by the appended claims.

What is claimed is:

1. A fluid for use in a wellbore operation in a subterranean formation for the production of hydrocarbons, comprising brine having salt comprising an ionic compound selected from the group consisting of zinc iodide, strontium bromide, strontium iodide, cerium bromide, cerium iodide, cerium chloride, lanthanum bromide, lanthanum iodide, lanthanum chloride, and mixtures thereof.

2. The fluid of claim 1 having a density in the range of about 13 lb/gal to about 23 lb/gal.

3. The fluid of claim 1 wherein the brine is used in a completion fluid and the wellbore operation is completing the wellbore.

4. The fluid of claim 1 wherein the fluid is a completion fluid.

5. The fluid of claim 1 wherein the fluid is a drill-in fluid.

6. The fluid of claim 1 wherein the brine is used in an invert emulsion and the wellbore operation is drilling the wellbore.

7. The fluid of claim 4 wherein the fluid is an invert emulsion drilling fluid.

8. The fluid of claim 1 consisting essentially of the brine, wherein the fluid is clear.

9. The fluid of claim 1 wherein the fluid is aqueous and the water comprising the brine is saturated with the ionic compound.

10. A method for conducting a wellbore operation in a subterranean formation for the production of hydrocarbons, comprising employing a clear brine in the wellbore operation where the brine comprises an ionic compound selected from the group consisting of zinc iodide, strontium bromide, strontium iodide, cerium bromide, cerium iodide, cerium chloride, lanthanum bromide, lanthanum iodide, lanthanum chloride, and mixtures thereof.

11. The method of claim 10 wherein the brine has a density in the range of about 13 lb/gal to about 23 lb/gal.

12. The method of claim 10 wherein the wellbore operation is drilling the wellbore and the brine is used in an invert emulsion drilling fluid.

13. The method of claim 10 wherein the wellbore operation is a completion operation and the brine is used in a completion fluid.

14. The method of claim 13 wherein the completion operation is drilling a well through a producing zone of the subterranean formation.

15. The method of claim 13 wherein the well comprises casing and the method further comprises perforating the casing and setting tubing in the wellbore

16. The method of claim 13 wherein the completion operation comprises completing a well drilled through a producing zone of the subterranean formation.

17. The method of claim 13 wherein the completion operation comprises a workover of the well penetrating the subterranean formation.

18. The method of claim 10 wherein the brine consists essentially of water and the ionic compound.

19. The method of claim 10 wherein the brine is saturated with the ionic compound.

20. An aqueous completion fluid for use in drilling, completing and/or working over a wellbore penetrating a subterranean formation, the fluid comprising a clear brine that remains clear during such use and that comprises an ionic compound selected from the group consisting of zinc iodide, strontium bromide, strontium iodide, cerium bromide, cerium iodide, cerium chloride, lanthanum bromide, lanthanum iodide, lanthanum chloride, and mixtures thereof.
